(19) United States
(12) Patent Application Publication
(10) Pub. No.: US 2024/0095581 A1
(43) Pub. Date: Mar. 21, 2024

(54) PROCESSING METHOD, PROCESSING SYSTEM, AND PROCESSING PROGRAM

(71) Applicant: NIPPON TELEGRAPH AND TELEPHONE CORPORATION, Tokyo (JP)

(72) Inventors: Kyoku SHI, Musashino-shi, Tokyo (JP); Shohei ENOMOTO, Musashino-shi, Tokyo (JP); Takeharu EDA, Musashino-shi, Tokyo (JP); Akira SAKAMOTO, Musashino-shi, Tokyo (JP)

(73) Assignee: NIPPON TELEGRAPH AND TELEPHONE CORPORATION, Tokyo (JP)

(21) Appl. No.: 18/038,211

(22) PCT Filed: Nov. 24, 2020
(86) PCT No.: PCT/JP2020/043686

§ 371 Date: May 23, 2023

(51) Int. Cl. G06N 20/00

(52) U.S. Cl. CPC G06N 20/00

(57) ABSTRACT

A processing method executed by a processing system that performs first inference in an edge device and performs second inference in a server device, the processing method includes determining whether or not a tendency of a target data group on which inference is performed is changed in at least one of the edge device or the server device on a basis of a variation in load or a decrease in inference accuracy in at least one of the edge device or the server device, and executing relearning of at least one of a first model that performs the first inference or a second model that performs the second inference in a case where it is determined that the tendency of the target data group is changed.

### TECHNICAL FIELD

The present invention relates to a processing method, a processing system, and a processing program.

### BACKGROUND ART

Since a data volume of data collected by an IoT device represented by a sensor is enormous, an enormous communication amount is generated when data collected by cloud computing is aggregated and processed. For this reason, even in an edge device close to a user, attention is focused on edge computing that processes collected data.

However, an amount of computation and resources such as a memory of a device used in the edge device are poor as compared with a device other than the edge device, the device being physically and logically disposed farther from the user than the edge device (hereinafter, the device is described as a cloud for convenience). For this reason, when processing with a large computation load is performed by the edge device, it may take a lot of time to complete the processing, or it may also take time to complete other processing with a small amount of computation.

Here, one of types of processing with a large amount of computation is processing related to machine learning. Non Patent Literature 1 proposes application of so-called adaptive learning to the edge cloud. That is, in a method described in Non Patent Literature 1, a learned model learned by using general-purpose learning data in a cloud is developed in an edge device, and learning is performed again on the model learned by the cloud by using data acquired by the edge device, whereby operation utilizing advantages of the cloud and the edge device is implemented.

### CITATION LIST

### Non Patent Literature

Non Patent Literature 1: Okoshi et al., “Proposal and Evaluation of DNN Model Operation Method with Cloud/Edge Collaboration”, Proceedings of the 80th National Convention, 2018(1), 3-4, 2018-03-13.

### SUMMARY OF INVENTION

### Technical Problem

Here, if the operation is continued, accuracy of the model may deteriorate as time passes. For this reason, it is necessary to maintain necessary accuracy by causing the models respectively disposed in the edge device and the cloud to execute relearning. However, for relearning of the model, it has been necessary for an administrator of a system to perform complicated processing of confirming all the data acquired during operation, determining which data is used and at which timing to execute relearning of the model for each model, and arranging relearning processing for the model.

The present invention has been made in view of the above, and an object thereof is to provide a processing method, a processing system, and a processing program capable of appropriately executing relearning of models respectively disposed in an edge and a cloud and maintaining accuracy of the models.

### Solution to Problem

To solve the above-described problem and achieve the object, a processing method according to the present invention is a processing method executed by a processing system that performs first inference in an edge device and performs second inference in a server device, the processing method including: a determination process of determining whether or not a tendency of a target data group on which inference is performed is changed in at least one of the edge device or the server device on a basis of a variation in load or a decrease in inference accuracy in at least one of the edge device or the server device; and a relearning process of executing relearning of at least one of a first model that performs the first inference or a second model that performs the second inference in a case where it is determined in the determination process that the tendency of the target data group is changed.

### Advantageous Effects of Invention

According to the present invention, it is possible to appropriately execute relearning of the models respectively disposed in the edge and the cloud, and maintain the accuracy of the models.

### BRIEF DESCRIPTION OF DRAWINGS

FIG. 1 is a diagram illustrating an outline of a processing method of a processing system according to an embodiment.

FIG. 2 is a diagram illustrating an example of a DNN1 and a DNN2.

FIG. 3 is a diagram schematically illustrating an example of a configuration of the processing system according to the embodiment.

FIG. 4 is a graph illustrating a relationship between an offload rate and overall accuracy.

FIG. 5 is a flowchart illustrating a processing procedure of learning data generation processing in the embodiment.

FIG. 6 is a flowchart illustrating a processing procedure of relearning determination processing for the DNN1 in the embodiment.

FIG. 7 is a flowchart illustrating a processing procedure of relearning determination processing for the DNN2 in the embodiment.

FIG. 8 is a diagram illustrating an example of a computer on which an edge device and a server device are implemented by executing a program.

### DESCRIPTION OF EMBODIMENTS

Hereinafter, an embodiment of the present invention will be described in detail with reference to the drawings. Note that the present invention is not limited by this embodiment. In addition, the same portions are denoted by the same reference signs in the description of the drawings.

### EMBODIMENT

[Outline of Embodiment] An embodiment of the present invention will be described. In the embodiment of the present invention, a processing system will be described that performs inference processing using a learned high-accuracy model and a learned lightweight model. Note that, in the processing system of the embodiment, a case will be described where a deep neural network (DNN) is used as a model used in the inference processing, as an example. In the processing system of the embodiment, a neural network other than the DNN may be used, and signal processing with a low amount of computation and signal processing with a high amount of computation may be used instead of the learned models.

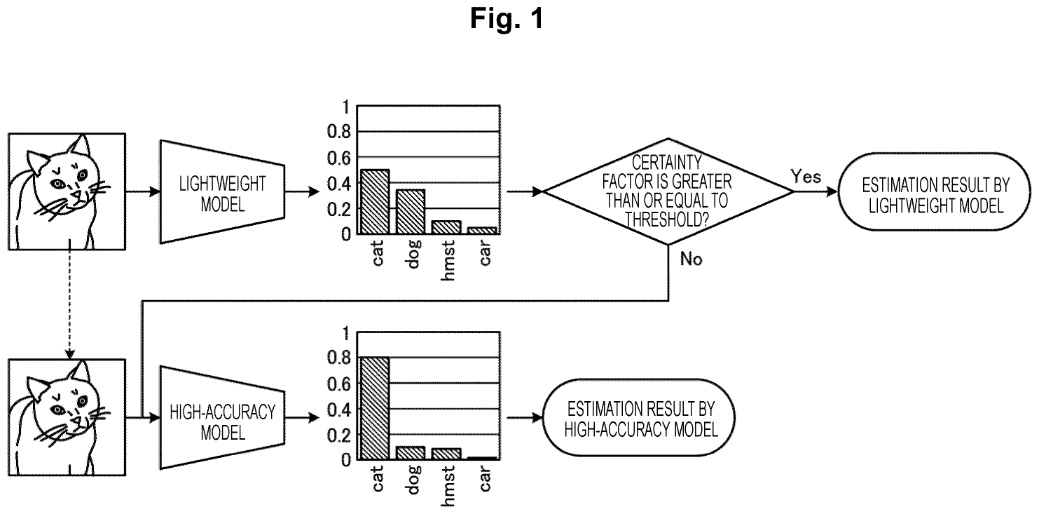

FIG. 1 is a diagram illustrating an outline of a processing method of the processing system according to the embodiment. The processing system of the embodiment configures a model cascade using the high-accuracy model and the lightweight model. In the processing system of the embodiment, it is controlled whether the processing is executed in an edge device using a high-speed and low-accuracy lightweight model (for example, a DNN1 (first model)) or a cloud (server device) using a low-speed and highly accurate high-accuracy model (for example, a DNN2 (second model)). For example, the server device is a device disposed at a place physically and logically far from a user. The edge device includes an IoT device and various terminal devices disposed at places physically and logically close to the user, and has fewer resources than those of the server device.

The DNN1 and the DNN2 are models that output inference results on the basis of input processing target data. In the example of FIG. 1, the DNN1 and the DNN2 use an image as an input and infer a probability for each class of an object appearing in the image. Note that two images illustrated in FIG. 1 are the same image.

As illustrated in FIG. 1, the processing system acquires a certainty factor of the inference of the class classification by the DNN1 for the object appearing in the input image. The certainty factor is a degree of certainty that a result of subject recognition by the DNN1 is correct. For example, the certainty factor may be a class probability of the object appearing in the image output by the DNN1, for example, the highest class probability.

Then, in the processing system, in a case where the acquired certainty factor is, for example, greater than or equal to a predetermined threshold, the inference result by the DNN1 is adopted. That is, the inference result by the lightweight model is output as a final estimation result of the model cascade. On the other hand, in the processing system, in a case where the certainty factor is less than the predetermined threshold, the inference result obtained by inputting the same image to the DNN2 is output as the final inference result.

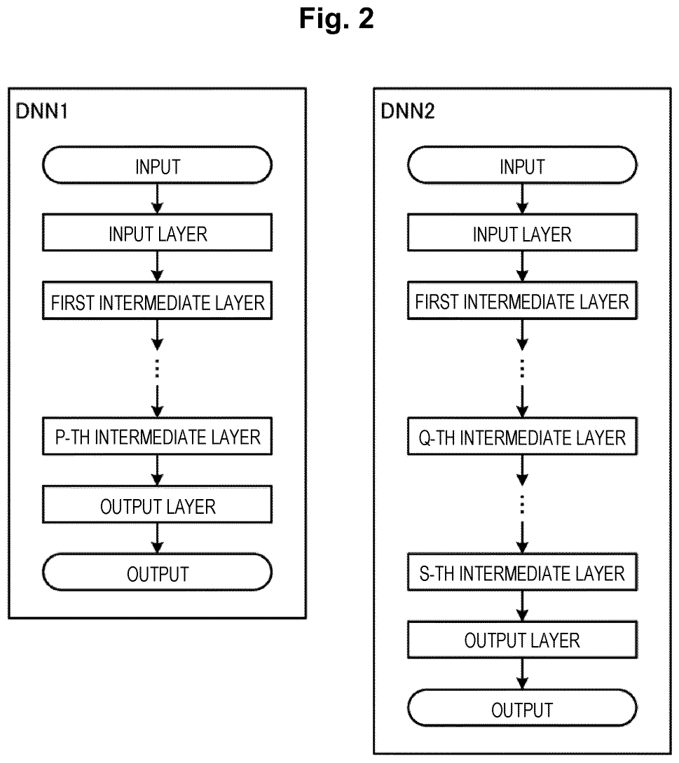

As described above, the processing system according to the embodiment selects the edge device or the server device on the basis of the certainty factor as to which of the edge device and the server device should process the processing target data, and processes the processing target data. [Lightweight Model and High-Accuracy Model] Next, the DNN1 and the DNN2 will be described. FIG. 2 is a diagram illustrating an example of the DNN1 and the DNN2. The DNN includes an input layer into which data is input, a plurality of intermediate layers that variously converts the data input from the input layer, and an output layer that outputs a so-called inferred result such as probability or likelihood. An output value output from each layer may be irreversible in a case where data to be input needs to maintain anonymity.

As illustrated in FIG. 2, the processing system may use the DNN1 and the DNN2 that are independent from each other. For example, after the DNN2 is trained in a known manner, the DNN1 may be trained using learning data used in training of the DNN2.

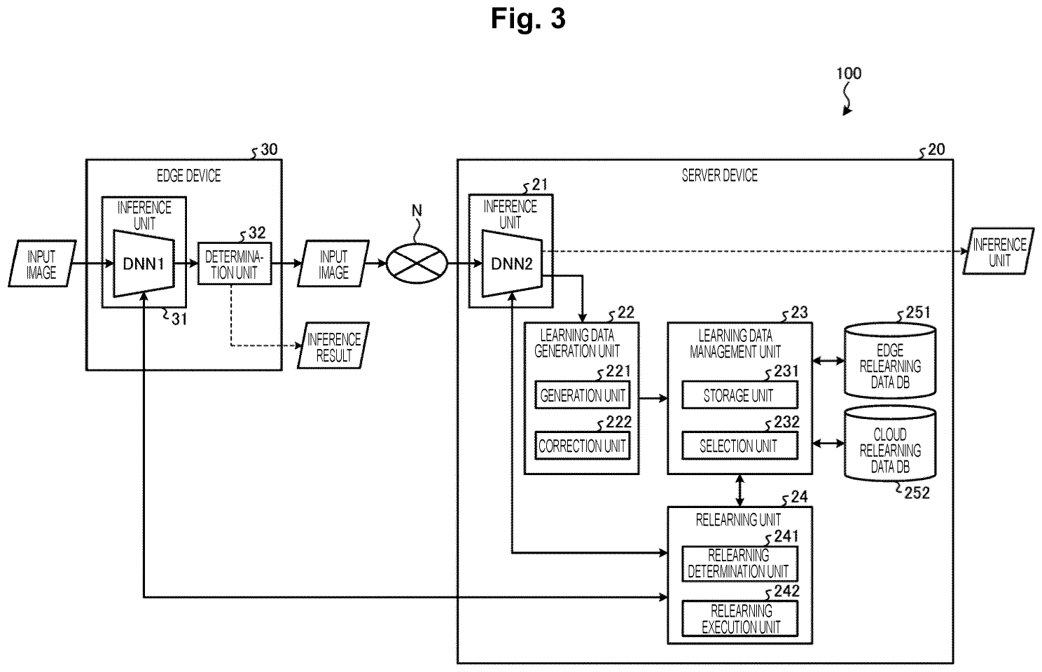

Here, it is sufficient that the DNN1 solves the same problem as the DNN2 and is lighter than the DNN2. For example, in the case of the example of FIG. 3, the DNN1 includes the first intermediate layer to the P-th (P<S) intermediate layer having fewer layers than the first intermediate layer to the S-th intermediate layer of the DNN2. As described above, the DNN1 and the DNN2 may be designed so that the DNN2 has deeper layers than the DNN1. In addition, darknetl9 (Hereinafter, it is referred to as YOLOv2.) that is a relatively lightweight and high-speed backend model of YOLOv2 may be selected as the DNN1, and darknet53 (Hereinafter, it is referred to as YOLOv3.) that is a relatively high-accuracy backend model of YOLOv3 may be selected as the DNN2. In a simple example, the DNN1 and the DNN2 may be configured to have different depths in the same NN. Any network may be used for each of the DNN1 and the DNN2. For example, CNN may be used.

In the present embodiment, a system is devised that determines a timing of relearning of the DNN1 and/or the DNN2 and automatically executes relearning of the DNN1 and the DNN2. Then, in the present embodiment, data for relearning is automatically selected and relearning is executed. As a result, according to the present embodiment, it is possible to appropriately execute relearning of models respectively disposed in the edge and the cloud, and maintain accuracy of the models while reducing a burden on an administrator regarding relearning processing for the models.

[Processing System] Next, a configuration of the processing system will be described. FIG. 3 is a diagram schematically illustrating an example of the configuration of the processing system according to the embodiment.

A processing system 100 according to the embodiment includes a server device 20 and an edge device 30. In addition, the server device 20 and the edge device 30 are connected to each other via a network N. The network N is, for example, the Internet. For example, the server device 20 is a server provided in a cloud environment. In addition, the edge device 30 includes, for example, an IoT device and various terminal devices. Note that, in the present embodiment, a case will be described where a target data group to be processed in the server device 20 and the edge device 30 is an image group, as an example.

A predetermined program is read by a computer or the like including a read only memory (ROM), a random access memory (RAM), a central processing unit (CPU), and the like, and the CPU executes the predetermined program, whereby each of the server device 20 and the edge device 30 is implemented. In addition, so-called accelerators are also used represented by a GPU, a vision processing unit (VPU), a field programmable gate array (FPGA), an application specific integrated circuit (ASIC), and a dedicated artificial intelligence (AI) chip. Each of the server device 20 and the edge device 30 includes a network interface card (NIC) or the like, and can perform communication with another device via a telecommunication line such as a local area network (LAN) or the Internet.

As illustrated in FIG. 3, the server device 20 includes an inference unit 21 that performs inference (second inference) using the DNN2 that is a learned high-accuracy model. The DNN2 includes information such as model parameters.

The inference unit 21 uses the DNN2 to execute the inference processing on an image output from the edge device 30. The inference unit 21 uses the image output from the edge device 30 as an input of the DNN2. The inference unit 21 executes the inference processing on the input image by using the DNN2. The inference unit 21 acquires an inference result (for example, a probability for each class of an object appearing in the image) as an output of the DNN2. It is assumed that the input image is an image whose label is unknown. In addition, in a case where the inference result is returned to a user, the inference result obtained by the inference unit 21 may be transmitted to the edge device 30 and returned from the edge device 30 to the user.

Here, the server device 20 and the edge device 30 constitute a model cascade. For this reason, the inference unit 21 does not always perform inference. The inference unit 21 receives an input of a divided image determined to cause the server device 20 to execute the inference processing in the edge device 30, and performs inference by the DNN2. Although description is made as the image here, the description may be a feature value extracted from the image instead of the image itself.

The edge device 30 includes an inference unit 31 including the DNN1 that is a learned lightweight model, and a determination unit 32.

The inference unit 31 inputs an image to be processed to the DNN1 and acquires an inference result. The inference unit 31 uses the DNN1 to execute the inference processing (first inference) on the input image. The inference unit 31 receives the input of the image to be processed, processes the image to be processed, and outputs the inference result (for example, a probability for each class of an object appearing in the image).

The determination unit 32 determines which inference result by the edge device 30 or the server device 20 is adopted by comparing the certainty factor with a predetermined threshold. In the present embodiment, the edge device 30 determines whether or not to adopt the inference result inferred by the edge device 30, and in a case where it is determined not to adopt the inference result, the inference result by the server device 20 is adopted.

In a case where the certainty factor is greater than or equal to the predetermined threshold, the determination unit 32 outputs the inference result inferred by the inference unit 31. In a case where the reliability is less than the predetermined threshold, the determination unit 32 outputs the image to be processed to the server device 20, and determines to cause the DNN2 disposed in the server device 20 to execute the inference processing.

Then, in the processing system 100, for example, the server device 20 is provided with a learning data generation unit 22, a learning data management unit 23, and a relearning unit 24 as functions related to the relearning processing for the DNN1 and the DNN2. Note that the learning data generation unit 22, the learning data management unit 23, and the relearning unit 24 may be provided not only in the server device 20 but also in another device that can communicate with the server device 20 and the edge device 30.

The learning data generation unit 22 generates learning data to be used at the time of relearning of the DNN1 and the DNN2 for each of the DNN1 and the DNN2. The learning data generation unit 22 generates, as the relearning data, data having a larger contribution to a variation in load or a decrease in inference accuracy in the image group for which the inference processing is actually executed during operation. The learning data generation unit 22 includes a generation unit 221 and a correction unit 222.

The generation unit 221 generates, as edge relearning data for the DNN1 of the edge device 30, data in which an image on which the inference is executed in the DNN2 among input images to the DNN2 is associated with an inference result by the DNN2 of the image as a label. The label of the learning data is added by automatic annotation. The generation unit 221 may separately generate learning data to be used at the time of relearning of the DNN1 and test data. As data for relearning of the DNN1, all data determined to be inferred on the server side may be targeted.

The correction unit 222 receives an input of correction for the inference result by the DNN2 on the input image. This correction is so-called manual annotation, and the administrator discriminates the image to be processed and corrects the inference result. Alternatively, the correction is processing of correcting the inference result by executing the inference processing using another mechanism different from the DNN2.

Then, the correction unit 222 generates, as cloud relearning data for the DNN2 of the server device 20, data in which the image on which the inference is executed in the DNN2 is associated with a corrected inference result (correct answer label) obtained by performing label correction to the inference result by the DNN2 of the image. The correction unit 222 may separately generate learning data to be used at the time of relearning of the DNN2 and test data.

The learning data management unit 23 manages learning data for relearning of the DNN1 and the DNN2 generated by the learning data generation unit 22. The learning data management unit 23 includes a storage unit 231 and a selection unit 232.

The storage unit 231 stores the edge relearning data for the DNN1 generated by the learning data generation unit 22 in an edge relearning data database (DB) 251. In a case where there is a plurality of the DNN1s, the storage unit 231 stores the edge relearning data separately for each of the DNN1s. The storage unit 231 stores the cloud relearning data for the DNN2 generated by the learning data generation unit 22 in a cloud relearning data DB 252. In a case where there is a plurality of the DNN2s, the storage unit 231 stores the cloud relearning data separately for each of the DNN2s.

In a case where the relearning unit 24 to be described later requests output of relearning data, the selection unit 232 extracts the relearning data according to the request from the edge relearning data DB 251 or the cloud relearning data DB 252, and outputs the relearning data to the relearning unit 24.

The relearning unit 24 executes relearning of at least one of the DNN1 or the DNN2. The relearning unit 24 includes a relearning determination unit 241 (determination unit) that determines whether or not it is possible to execute relearning of the DNN1 or the DNN2, and a relearning execution unit 242 (relearning unit).

The relearning determination unit 241 determines whether or not a tendency of the image group on which the inference is performed is changed in at least one of the edge device 30 or the server device 20 on the basis of the variation in load or the decrease in inference accuracy in at least one of the edge device 30 or the server device 20. Then, in a case where it is determined that the tendency of the image group is changed, the relearning determination unit 241 determines to execute relearning of the DNN1 or the DNN2. The relearning determination unit 241 determines to execute relearning of the DNN1 or the DNN2 depending on a change in an offload rate (processing rate in the server device 20) from a set value, the decrease in inference accuracy, or an amount of learning data held. In addition, when the offload rate decreases, the administrator of the system determines whether to perform relearning on the basis of the inference accuracy. This is because it is not always necessary to perform relearning of the DNN1 when the offload rate decreases. In a case where the offload rate increases, the change in the offload rate may be used as a trigger for relearning of the DNN1. In the server device 20, in accordance with necessity of relearning determined in this manner, an instruction is given to execute relearning, and in accordance with the instruction, the relearning determination unit 241 executes relearning of the DNN1 or the DNN2. Note that, since the DNN2 infers data offloaded from the plurality of DNN1s as a target in many cases, it is preferable to perform the inference on the basis of a correction rate instead of the offload rate.

In a case where it is determined by the relearning determination unit 241 that the tendency of the image group is changed, the relearning execution unit 242 executes relearning of at least one of the DNN1 or the DNN2. The relearning execution unit 242 executes relearning of at least one of the DNN1 or the DNN2 by using data having a larger contribution to the variation in load or the decrease in inference accuracy in the image group.

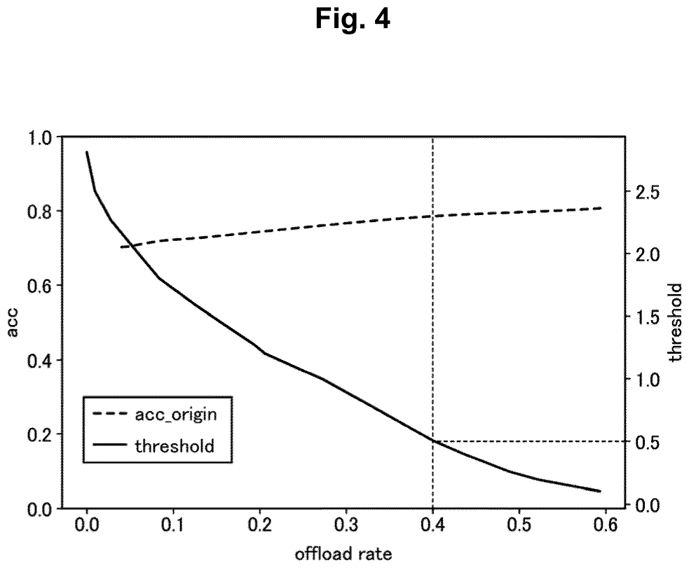

The relearning execution unit 242 executes relearning of the DNN1 by using the edge relearning data as learning data. The relearning execution unit 242 executes relearning of the DNN2 by using the cloud relearning data as learning data. The relearning execution unit 242 transmits the DNN1 obtained by relearning the DNN1 (or a model equivalent to the DNN1) to the edge device 30 and disposes the DNN1 as an edge-side model. The relearning execution unit 242 outputs the DNN2 obtained by relearning the DNN2 (or a model equivalent to the DNN2) to the inference unit 21 and disposes the DNN2 as a cloud-side model. Note that the DNN1 and the DNN2 used for relearning and the DNN1 and the DNN2 after relearning may be held in the server device 20 or may be held in another device capable of communicating with the edge device 30 and the server device 20.

[Threshold of Certainty Factor and Offload Rate] How to determine the threshold of the certainty factor and the offload rate will be described. FIG. 4 is a graph illustrating a relationship between the offload rate and overall accuracy. FIG. 4 is obtained by obtaining a variation in the overall accuracy of the inference result accompanying a variation in the offload rate on the basis of the inference result during operation. Note that the threshold is linked with the offload rate, and the threshold of the certainty factor is increased in a case where the offload rate is decreased. In FIG. 4, “Offload rate 0” is a state in which all the data is processed by the edge device 30 and the accuracy (acc_origin) is low, and “Offload rate 1” is a state in which all the data is processed by the server device 20 and the accuracy (acc_origin) is high.

In addition, when the offload rate exceeds 0.4 (threshold is 0.5), improvement in accuracy is small even if the offload rate is increased, that is, even if the threshold of the certainty factor is decreased. For this reason, when the threshold of the certainty factor is set to 0.5, it is considered that the offload rate (0.4) and the accuracy (0.75) are balanced. In other words, when the offload rate is set to 0.4, the threshold of the certainty factor is set to 0.5. As described above, by setting the threshold according to the balance between the offload rate and the accuracy, the offload rate and the overall accuracy can be adjusted according to each use case.

Statistics can be taken of the offload rate at the time of operation. For a method of taking statistics of the offload rate, an amount of transmission transmitted from the DNN1 to the DNN2, that is, the edge device 30 to the server device 20 may be used as an index value. For example, in a case where the inference processing that is processed per unit time in the edge device 30, for example, inference of 5 frames per second is performed, and the amount of transmission corresponding to 2 frames has occurred, the offload rate can be estimated to be 0.4. As described above, it is possible to take statistics of the offload rate and detect a change in the offload rate.

[Processing of Relearning Determination Unit] The relearning determination unit 241 determines whether or not to execute relearning of the DNN1 or the DNN2 on the basis of the change in the offload rate from the set value, the decrease in inference accuracy, and the amount of learning data.
[Determination of Relearning of DNN1] The relearning determination unit 241 determines execution of relearning of the DNN1 in the edge device 30 in the following cases.

First, the relearning determination unit 241 determines execution of relearning of the DNN1 in a case where the offload rate changes from the set value. In this case, it is considered that the offload rate increases due to a change in the tendency of the inference target image group, and the number of pieces of processing in the server device 20 increases. That is, it is detected that overall calculation cost varies as the number of pieces of processing in the server device 20 increases. In such a case, it is considered that the accuracy of the DNN1 is decreased since inference results increases in which the certainty factor of the inference result by the DNN1 in the edge device 30 falls below the predetermined threshold. Note that the setting value may be a setting range, and execution of relearning may be determined in any case of a case where the certainty factor is a value above the setting range and a case where the certainty factor is a value below the setting range.

In addition, the relearning determination unit 241 determines execution of relearning of the DNN1 in a case where the inference accuracy by the DNN1 is decreased to be lower than a predetermined accuracy. In this case, it is determined by the administrator of the system that the inference accuracy by the DNN1 is decreased, and an instruction is given to execute relearning of the DNN1. In addition, the relearning determination unit 241 determines execution of relearning of the DNN1 in a case where the edge relearning data reaches a batch amount.

Then, the relearning determination unit 241 executes relearning of the DNN2 in the server device 20 in the following cases. Specifically, the relearning determination unit 241 determines execution of relearning of the DNN2 in a case where the inference accuracy by the DNN2 is decreased to be lower than a predetermined accuracy. In this case, it is determined by the administrator of the system that the inference accuracy by the DNN2 is decreased, and an instruction is given to execute relearning of the DNN2.

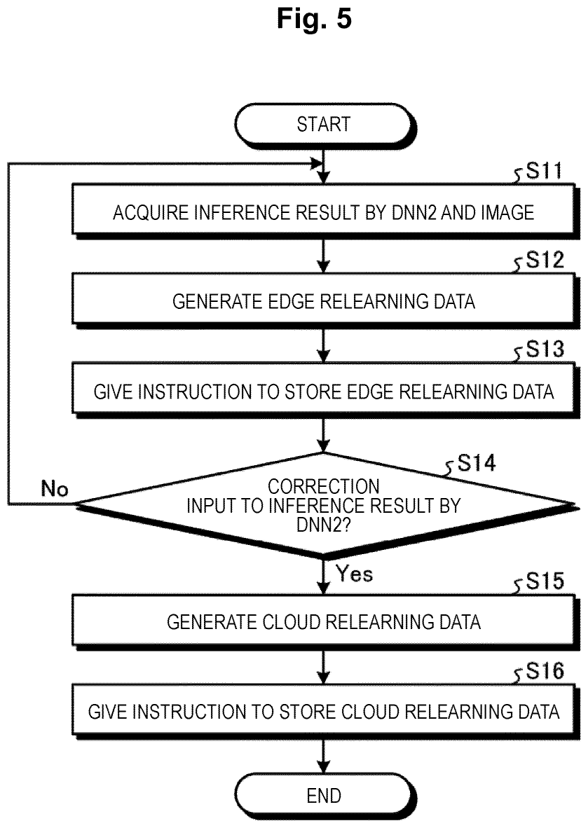

In addition, the relearning determination unit 241 determines execution of relearning of the DNN2 in a case where the correction rate for the inference result by the DNN2 by the correction unit 222 is greater than or equal to a predetermined rate. This is because it is determined that the inference accuracy by the DNN2 is decreased. In addition, the relearning determination unit 241 determines execution of relearning of the DNN2 in a case where the cloud relearning data reaches a batch amount.

[Learning Data Generation Processing] Next, learning data generation processing in the server device 20 will be described. FIG. 5 is a flowchart illustrating a processing procedure of learning data generation processing in the embodiment.

As illustrated in FIG. 5, in the server device 20, the generation unit 221 acquires the inference result by the DNN2 and the image on which the inference is executed in the DNN2 (step S11). Subsequently, the generation unit 221 generates, as the edge relearning data, data in which the image on which the inference is executed in the DNN2 is associated with the inference result by the DNN2 of the image as a label (step S12), and instructs the storage unit 231 to store the data in the edge relearning data DB 251 (step S13).

Then, the learning data generation unit 22 determines whether or not an input of correction to the inference result by the DNN2 is received (step S14). In a case where the input of correction to the inference result by the DNN2 of the input image has not been received (step S14: No), the learning data generation unit 22 returns to step S11.

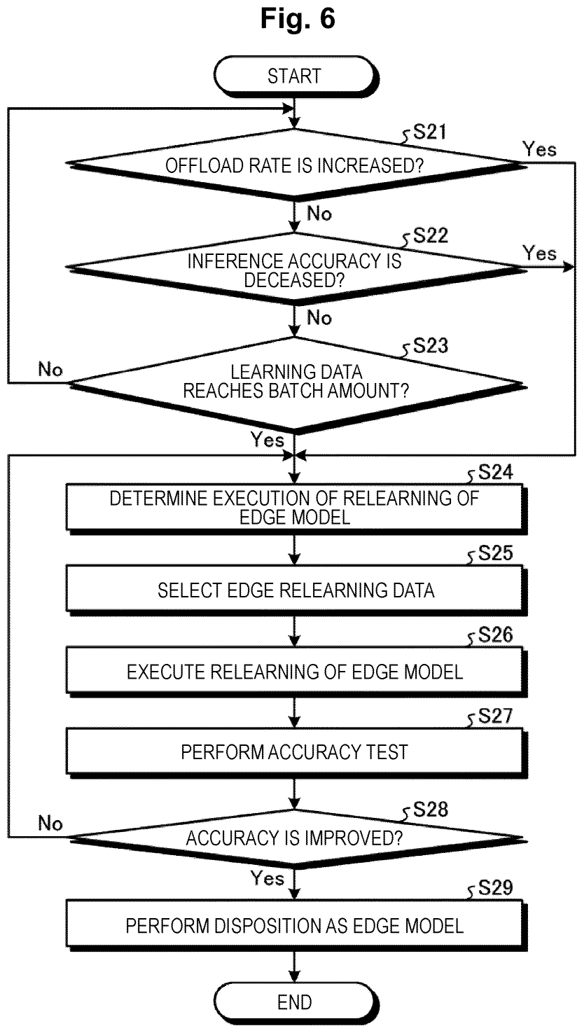

When receiving the input of correction to the inference result by the DNN2 of the input image (step S14: Yes), the correction unit 222 generates, as cloud relearning data for the DNN2 of the server device 20, the image on which the inference is executed in the DNN2 and the data with which the corrected inference result (correct answer label) of the image is associated (step S15). Then, the correction unit 222 instructs the storage unit 231 to store the data in the cloud relearning data DB 252 (step S16).

[Relearning Determination Processing for DNN1] Next, relearning determination processing for the DNN1 will be described. FIG. 6 is a flowchart illustrating a processing procedure of relearning determination processing for the DNN1 in the embodiment.

As illustrated in FIG. 6, the relearning determination unit 241 determines whether or not the offload rate is increased from the set value (step S21). In a case where the offload rate is not increased from the set value (step S21: No), the relearning determination unit 241 determines whether or not the inference accuracy by the DNN1 is decreased to be lower than the predetermined accuracy (step S22). In a case where the inference accuracy by the DNN1 is not decreased to be lower than the predetermined accuracy (step S22: No), the relearning determination unit 241 determines whether or not the edge relearning data reaches the batch amount (step S23). In a case where the edge relearning data does not reach the batch amount (step S23: No), the relearning determination unit 241 returns to step S21 and performs determination on the change in the offload rate.

In a case where the offload rate is increased from the set value (step S21: Yes), or in a case where the inference accuracy by the DNN1 is decreased to be lower than the predetermined accuracy (step S22: Yes), or in a case where the edge relearning data reaches the batch amount (step S23: Yes), the relearning determination unit 241 determines execution of relearning of the DNN1 (step S24).

Subsequently, the relearning execution unit 242 requests the selection unit 232 to output the edge relearning data, so that the selection unit 232 selects the edge relearning data (step S25) and outputs the edge relearning data to the relearning execution unit 242. The relearning execution unit 242 executes relearning of the DNN1 by using the edge relearning data as learning data (step S26).

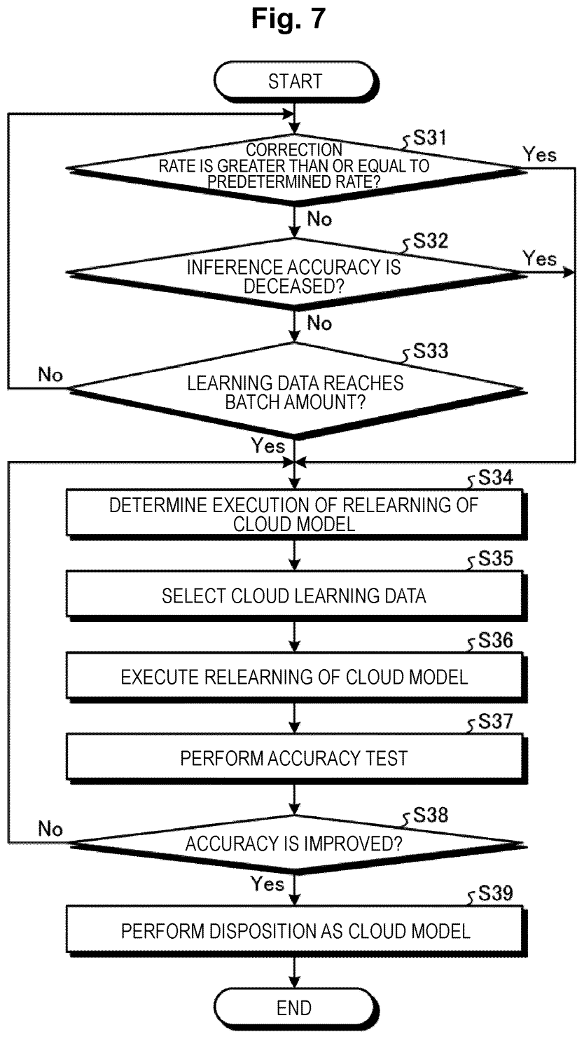

The relearning execution unit 242 performs an accuracy test with test data corresponding to the DNN1 (step S27), and in a case where the accuracy is improved (step S28: Yes), sets the offload rate and the threshold of the certainty factor corresponding to the offload rate, and disposes the relearned DNN1 as a model of the edge device 30 (step S29). Note that, in a case where the accuracy of the relearned DNN1 is not improved (step S28: No), it is assumed that the inference accuracy by the DNN2 is also decreased. In such a case, the relearning execution unit 242 returns to step S24 and only needs to perform relearning of the DNN1 by relabeling heuristically or by using data relabeled with a DNN (for example, a DNN with higher load and higher accuracy) different from the DNN2. In such a case, relearning should be similarly performed for the DNN2.

[Relearning Determination Processing for DNN2] Next, relearning determination processing for the DNN2 will be described. FIG. 7 is a flowchart illustrating a processing procedure of relearning determination processing for the DNN2 in the embodiment.

As illustrated in FIG. 7, the relearning determination unit 241 determines whether or not the correction rate for the inference result by the DNN2 by the correction unit 222 is greater than or equal to the predetermined rate (step S31). In a case where the correction rate for the inference result by the DNN2 by the correction unit 222 is not greater than or equal to the predetermined rate (step S31: No), the relearning determination unit 241 determines whether or not the inference accuracy is decreased to be lower than the predetermined accuracy (step S32). In a case where the inference accuracy is not decreased to be lower than the predetermined accuracy (step S32: No), the relearning determination unit 241 determines whether or not the cloud relearning data reaches the batch amount (step S33). In a case where the cloud relearning data does not reach the batch amount (step S33: No), the relearning determination unit 241 returns to step S31 and performs determination on the change in the offload rate.

In a case where the correction rate for the inference result by the DNN2 by the correction unit 222 is greater than or equal to the predetermined rate (step S31: Yes), or in a case where the inference accuracy is decreased to be lower than the predetermined accuracy (step S32: Yes), or in a case where the cloud relearning data reaches the batch amount (step S33: Yes), the relearning determination unit 241 determines execution of relearning of the DNN2 (step S34).

Subsequently, the relearning execution unit 242 requests the selection unit 232 to output the cloud relearning data, so that the selection unit 232 selects the cloud relearning data (step S35) and outputs the cloud relearning data to the relearning execution unit 242. The relearning execution unit 242 executes relearning of the DNN2 by using the cloud relearning data as learning data (step S36). The relearning execution unit 242 performs an accuracy test with test data corresponding to the DNN2 (step S37), and in a case where the accuracy is improved (step S38: Yes), disposes the relearned DNN2 as a model of the server device 20 (step S39). In a case where there is no improvement in accuracy (step S38: No), the relearning execution unit 242 proceeds to step S34 and executes relearning.

[Effects of Embodiment] As described above, in the processing system 100 according to the present embodiment, it is determined whether or not the tendency of the image group (target data group) on which the inference is performed is changed in at least one of the edge device 30 or the server device 20 on the basis of the variation in load or the decrease in inference accuracy in at least one of the edge device and the server device. Then, in a case where it is determined that the tendency of the image group is changed, the processing system 100 executes relearning of at least one of the DNN1 or the DNN2. Thus, according to the processing system 100, the timing of relearning is determined for each of the DNN1 and the DNN2, and the relearning of the DNN1 and the DNN2 can be automatically executed.

Then, in the processing system 100, the relearning of at least one of the DNN1 or the DNN2 is executed by using the data having a larger contribution to the variation in load or the decrease in inference accuracy in the image group processed during the operation of the system, so that, by the relearning, it is possible to construct the DNN1 and the DNN2 that can cope with the variation in load or the decrease in inference accuracy. Then, in the processing system 100, by disposing the DNN1 and the DNN2 in the edge device 30 and the server device 20, it is possible to maintain the accuracy of the models respectively disposed in the edge and the cloud.

In the processing system 100, an image on which the inference processing is actually executed in the DNN2 in the image group processed during the operation of the system and an inference result by the DNN2 of the image are used as learning data to execute relearning of the DNN1. In other words, in the processing system 100, an image that is actually inferred in the DNN1 and to which an inference result by the DNN2 with higher accuracy than that of the DNN1 is attached as a label is generated as edge relearning data, and relearning of the DNN1 is performed by using the edge relearning data. For this reason, the DNN1 becomes a domain-specific model each time relearning is performed, and the accuracy required for the edge device 30 can be appropriately maintained.

Then, in the processing system 100, in the image group processed during the operation of the system, the image on which the inference processing is actually executed in the DNN2 and a corrected inference result obtained by correcting the inference result by the DNN2 of the image are used as learning data to perform relearning of the DNN2. That is, in the DNN2, an image in which the inference performed in the DNN2 is wrong and to which a correct answer label is attached is generated as cloud relearning data, and relearning of the DNN2 is performed by using the cloud relearning data, so that the accuracy of the DNN2 can be improved.

As described above, according to the processing system 100, it is possible to appropriately execute relearning of the models respectively disposed in the edge and the cloud and maintain the accuracy of the models while reducing the burden on the administrator regarding the relearning processing for the models.

Note that, in the present embodiment, a plurality of the edge devices 30 or a plurality of the server devices 20 may be provided, and both the plurality of edge devices 30 and the plurality of server devices 20 may be provided. At that time, the edge relearning data is generated for each edge device 30, the cloud relearning data is generated for each server device 20, and relearning of each model is executed by using corresponding learning data.

[System Configuration etc.] Each component of each device that has been illustrated is functionally conceptual, and is not necessarily physically configured as illustrated. That is, a specific form of distribution and integration of each device is not limited to the illustrated form. All or some of the components may be functionally or physically distributed and integrated in an arbitrary unit according to various loads, usage conditions, and the like. Furthermore, all or any part of each processing function performed in each device can be implemented by a CPU and a program analyzed and executed by the CPU, or can be implemented as hardware by wired logic.

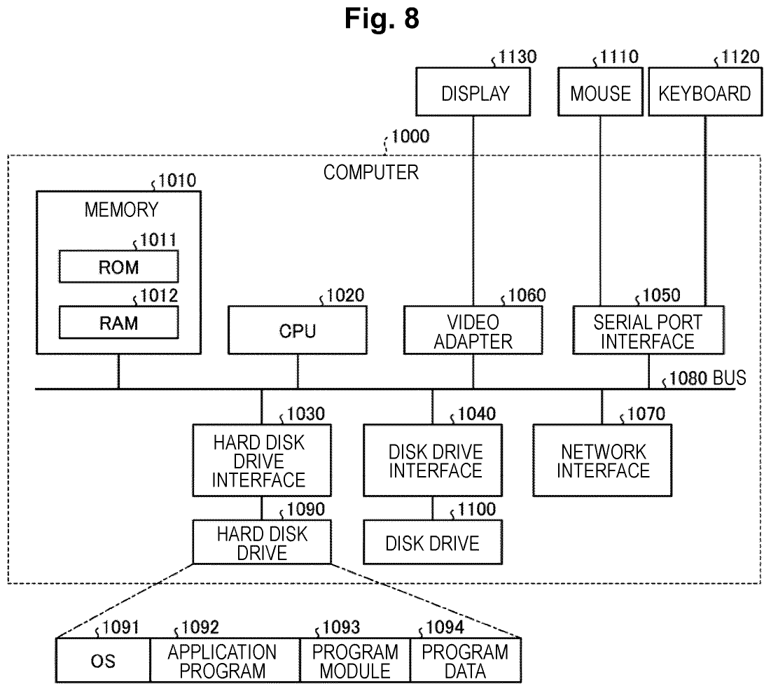

In addition, among pieces of processing described in the present embodiment, all or some of pieces of processing described as being performed automatically can be performed manually, or all or some of pieces of processing described as being performed manually can be performed automatically by a known method. In addition, the processing procedures, the control procedures, the specific names, and the information including various data and parameters illustrated in the specification and the drawings can be arbitrarily changed unless otherwise specified.

[Program] FIG. 8 is a diagram illustrating an example of a computer on which the edge device 30 and the server device 20 are implemented by executing a program. A computer 1000 includes, for example, a memory 1010 and a CPU 1020. In addition, the accelerators described above may be provided to assist computation. In addition, the computer 1000 also includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an operating system (OS) 1091, an application program 1092, a program module 1093, and program data 1094. That is, a program that defines each piece of processing of the edge device 30 and the server device 20 is implemented as the program module 1093 in which a code executable by the computer is described. The program module 1093 is stored in, for example, the hard disk drive 1090. For example, the program module 1093 for executing processing similar to functional configurations of the edge device 30 and the server device 20 is stored in the hard disk drive 1090. Note that the hard disk drive 1090 may be replaced with a solid state drive (SSD).

In addition, setting data used in the processing of the above-described embodiment is stored, for example, in the memory 1010 or the hard disk drive 1090 as the program data 1094. Then, the CPU 1020 reads and executes the program module 1093 and the program data 1094 stored in the memory 1010 or the hard disk drive 1090 to the RAM 1012, as necessary.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). Then, the program module 1093 and the program data 1094 may be read by the CPU 1020 from another computer via the network interface 1070.

Although the embodiment to which the invention made by the present inventor is applied has been described above, the present invention is not limited by the description and drawings constituting a part of the disclosure of the present invention according to the present embodiment. In other words, other embodiments, examples, operation techniques, and the like made by those skilled in the art and the like on the basis of the present embodiment are all included in the scope of the present invention.

### REFERENCE SIGNS LIST

20 server device
21, 31 inference unit
22 learning data generation unit
23 learning data management unit
24 relearning unit
30 edge device
32 determination unit
100 processing system
221 generation unit
222 correction unit
231 storage unit
232 selection unit
241 relearning determination unit
242 relearning execution unit
251 edge relearning data DB
252 cloud relearning data DB

1. A processing method executed by a processing system that performs first inference in an edge device and performs second inference in a server device, the processing method comprising:
determining whether or not a tendency of a target data group on which inference is performed is changed in at least one of the edge device or the server device on a basis of a variation in load or a decrease in inference accuracy in at least one of the edge device or the server device; and
executing relearning of at least one of a first model that performs the first inference or a second model that performs the second inference in a case where it is determined that the tendency of the target data group is changed.

2. The processing method according to claim 1, wherein the relearning of at least one of the first model or the second model is executed by using data having a larger contribution to the variation in load or the decrease in inference accuracy in the target data group.

3. The processing method according to claim 1, wherein target data on which the second inference is executed and an inference result in the second inference of the target data in the target data group are set as learning data, and the relearning of the first model is executed.

4. The processing method according to claim 1, wherein target data on which the second inference is executed and a corrected inference result obtained by correcting an inference result in the second inference of the target data in the target data group are set as learning data, and the relearning of the second model is executed.

5. A processing system that performs first inference in an edge device and performs second inference in a server device, the processing system comprising:
processing circuitry configured to:
determine whether or not a tendency of a target data group on which inference is performed is changed in at least one of the edge device or the server device on a basis of a variation in load or a decrease in inference accuracy in at least one of the edge device or the server device; and
execute relearning of at least one of a first model that performs the first inference or a second model that performs the second inference in a case where it is determined that the tendency of the target data group is changed.

6. A non-transitory computer-readable recording medium storing therein a processing program that causes a computer to execute a process comprising:
determining whether or not a tendency of a target data group on which inference is performed is changed in at least one of an edge device or a server device on a basis of a variation in load or a decrease in inference accuracy in at least one of the edge device or the server device; and
executing relearning of at least one of a first model that performs first inference in the edge device or a second model that performs second inference in the server device in a case where it is determined that the tendency of the target data group is changed.
